(19) United States
(12) Patent Application Publication
(10) Pub. No.: US 2025/0199306 A1
(43) Pub. Date: Jun. 19, 2025

(54) WAVEFRONT MANIPULATOR FOR HEAD-UP DISPLAY WITH HOLOGRAPHIC ELEMENT TO CREATE A TILTED VIRTUAL IMAGE PLANE

(71) Applicant: Carl Zeiss Jena GmbH, Jena (DE)

(72) Inventor: Yi ZHONG-SCHIPP, Jena (DE)

(21) Appl. No.: 18/843,603

(22) PCT Filed: Feb. 23, 2023
(86) PCT No.: PCT/EP2023/054540

§ 371 Date: Sep. 3, 2024

(30) Foreign Application Priority Data
Mar. 3, 2022 (DE) 10 2022 105 039.4

(51) Int. Cl. G02B 27/01

(52) U.S. Cl. CPC G02B 27/0103; G02B 2027/011

(57) ABSTRACT

A wavefront manipulator includes a holographic assembly which has at least two holographic elements, which are arranged directly behind one another in the beam path, at least in sections, and are designed to be reflective for at least one fixed wavelength and a fixed irradiation angle range. A first holographic element includes at least one hologram which is assigned to a hologram of a second holographic element for reflection purposes. The wavefront manipulator is designed for at least one fixed object plane to generate an image plane of a virtual image which is tilted about a fixed tilt angle θ with respect to a plane arranged perpendicular to the optical axis in the region of the image plane of a virtual image. The holographic arrangement is designed for at least partial correction of at least one imaging error of a virtual image generated in the tilted image plane.

### PRIORITY

This application claims the benefit of German Patent Application No. 10 2022 105 039.4 filed on Mar. 3, 2022, which is hereby incorporated herein by reference in its entirety.

### FIELD

The present invention relates to a wavefront manipulator for arrangement in the beam path of a head-up display (HUD) between a projection lens and a projection surface, in particular a curved projection surface. The invention furthermore relates to an optical arrangement and to a head-up display.

### BACKGROUND

Head-up displays are now being used in the context of diverse applications, inter alia also in association with observation windows of vehicles, for example on windshields of motor vehicles, front screens or observation windows of aircraft. These viewing windows, and in particular windshields, usually have a curved surface which is used as a projection surface of head-up displays.

A head-up display usually comprises a picture generating unit (PGU) or a projector, a projection surface, an eyebox and an image plane of the virtual image representation. An image representation is created by means of the picture generating unit or the projector. The image is projected onto the projection surface and is projected from the projection surface into the eyebox. The eyebox is a plane or a spatial region in which the projected image is perceptible to a viewer as a virtual image. The image plane of the virtual image representation, i.e. the plane on or in which the virtual image is created, is arranged on or behind the projection surface.

Imaging aberrations, or aberrations, occur as a result of the curvature of the projection surface and as a result of compact arrangements in a small installation space with, under certain circumstances, severe tilting of individual components with respect to one another and correspondingly complexly folded beam paths. A windshield can generally be described as an optical freeform surface. If a head-up display is used in association with a curved windshield or a curved observation window, then it is desirable to correct imaging aberrations that occur as a result of the curvature, the abovementioned imaging aberrations that may occur for reasons of structural space, and imaging aberrations potentially caused by the picture generating unit in the optical beam path. The imaging aberrations, or aberrations, which can occur in this case are, for example, distortion, defocus, tilting, astigmatism, curvature of the image plane, spherical aberrations, higher astigmatism and coma. Moreover, the largest possible field of view, the largest possible eyebox and also a uniform, bright and multicolored image representation, preferably multicolored at each image point, are desirable in association with head-up displays, in particular for vehicle applications.

Documents DE 10 2007 022 247 A1, DE 10 2015 101 687 A1, DE 10 2017 212 451 A1 and DE 10 2017 222 621 A1 describe holographic imaging optics for head-up displays, especially in the context of windshields. In the context of head-up displays, it is increasingly necessary and desirable to image information or multicolored image representations at different image distances. To reduce the costs and maintain the stability of the system, it is also necessary for the components used in the head-up display to be fixedly installed or arranged fixedly in relation to one another.

The documents JP 2021-012 255 A and JP 2015-18 099 A disclose head-up displays comprising a tilted virtual image plane.

### SUMMARY

An object herein is to provide an advantageous wavefront manipulator for arrangement in the beam path of a head-up display between a projection lens and a curved projection surface, which wavefront manipulator at least partly meets the aforementioned requirements and at least partly corrects imaging aberrations mentioned above. Further objects include providing an advantageous optical arrangement for a head-up display on a curved projection surface, and also an advantageous head-up display.

The wavefront manipulator in certain example embodiments is for arrangement in the beam path of a head-up display between a picture generating unit (PGU) or a projection lens and a projection surface, for example a curved projection surface, comprises a holographic arrangement. The holographic arrangement, which can be configured to be transmissive and/or reflective overall, comprises at least two holographic elements. The at least two holographic elements are arranged one directly behind another at least in portions in the beam path. In other words, no further optical element or component is arranged between the at least two holographic elements. The at least two holographic elements are furthermore configured to be reflective for at least one defined wavelength, in particular at least one defined wavelength range, and a defined angle of incidence range, a first holographic element comprising at least one hologram which is assigned to a hologram of a second holographic element for reflection purposes. In other words, the at least two holographic elements are formed such that light at at least one wavelength and at least one angle of incidence that is reflected by a first holographic element is reflected by the second holographic element. Preferably, the holographic elements are otherwise configured to be transmissive. The second holographic element can be arranged in the beam path upstream of the first holographic element. In this variant, therefore, the light beams are at least partly transmitted through this before the light beams are reflected at the first holographic element.

For at least one defined object plane, possibly formed by the plane of an exit pupil of a picture generating unit for example, the wavefront manipulator is designed to create an image plane of a virtual image representation, the image plane being tilted through a defined tilt angle θ with respect to a plane arranged perpendicular to the optical axis in the region of the image plane of a virtual image representation. In this case, tilted means that the tilt angle θ is not equal to 0 degrees. In other words, there exist at least two image points in the tilted image plane which have different distances from the eyebox. The aforementioned optical axis can also be defined as the optical axis or virtual chief ray direction from the eyebox toward the image plane of the virtual image representation. The holographic arrangement is designed for at least partial correction of at least one imaging aberration, preferably a plurality of imaging aberrations, of a virtual image representation created in the tilted image plane. For example, the imaging aberrations might be caused by the image plane tilt, a projection surface curvature, a beam path expansion, etc.

The wavefront manipulator is advantageous in that different image distances can be created in an image plane, and the image plane can be designed clearer in relation to the arrangement of information as a result of the depth dimension. For example, information items can be projected at different image distances. This is especially relevant in the context of head-up displays for vehicles. In the case of a tilted image plane in which the upper region of the image plane has a greater image distance from the eyebox than the lower region of the image plane, information items in the lower region of the image plane can be imaged at a shorter distance. For example, information regarding the vehicle speed can be placed here. In the upper region of the image plane, information items can be imaged further away from an observer or an eye box. For example, these could be navigation information items or alerts.

The tilt angle θ can be between 10 degrees and 170 degrees and preferably between 30 degrees and 170 degrees, for example between 40 degrees and 50 degrees or between 130 degrees and 140 degrees.

The defined object plane can be arranged tilted through a defined tilt angle with respect to a plane arranged perpendicular to the optical axis at the object plane or in the region of the object plane.

In a further variant, the at least two holographic elements are arranged at a distance from one another of no more than 50 millimeters, e.g. no more than 10 millimeters and preferably no more than 1 millimeter. In addition to that or in an alternative, the at least two holographic elements can be arranged tilted in relation to one another, said elements forming an angle of no more than 30 degrees, e.g. no more than 10 degrees and preferably no more than 5 degrees. In particular, the at least two holographic elements can have respective surface normals, the surface normals of two holographic elements forming an angle of no more than 30 degrees, e.g. no more than 10 degrees, preferably no more than 5 degrees. The at least two holographic elements are preferably arranged parallel to one another and/or directly adjacent to one another.

The use of two holographic elements arranged one directly behind another and configured to be at least partly reflective has the advantage that in particular in the context of a head-up display, a large field of view (FOV) can be attained with high efficiency and the imaging quality can be considerably improved by way of the individual configuration of the holographic elements. For this purpose, the holographic elements take up almost no installation space, and so when there is only little available installation space, such as in the case of a head-up display designed for a motor vehicle, for example, a significant increase in the imaging quality can be achieved by means of the wavefront manipulator. The holographic arrangement achieves a high refractive power, in particular, comparable with the refractive power such as is achieved for example by an optical component configured to be transmissive without chromatic aberration. Compared with transmission holograms, reflective holograms for a defined wavelength offer a broader angular spectrum with a high efficiency and a higher wavelength selectivity.

As a result, the color channels can be separated from one another despite a broad angle of incidence spectrum and double images can be avoided. The holographic arrangement thus enables a large field of view (FOV) with high efficiency at the same time and is thus suitable both for VR head-up displays (VR—Virtual Reality) and augmented reality head-up displays (AR HUDs) with a large field of view and a large numerical aperture. Further application possibilities are afforded by head-up displays having curved projection surfaces, for example head-up displays for windshields of vehicles, in particular motor vehicles, aircraft or ships, and generally for observation windows. Moreover, aberrations caused by the tilt of the image plane, such as for example brightness differences and distortions, especially keystone distortions, can also be corrected by means of the holographic arrangement. In other words, the holographic arrangement of an advantageous variant is designed for at least partial correction of at least one imaging aberration caused by the tilt of the image plane. The at least one imaging aberration can be the aforementioned aberrations. However, these aberrations can also be corrected digitally.

A further advantage achieved by the holographic arrangement is that, on account of the high diffraction angle of the holographic arrangement, the proportion of the light from unused orders of diffraction which is reflected into the eyebox is reduced. Furthermore, high-quality multicolored image representations can be created.

Advantageously, the wavefront manipulator is designed for manipulating a wavefront for creating a multicolored virtual image representation. This is taken to mean that a multicolored virtual image representation is creatable at every point on the tilted image plane. The wavefront manipulator can thus be designed to manipulate light with the wavelengths or frequencies of at least one defined color space and to convert it into a multicolored virtual image representation in the context of a head-up display. In other words, the wavefront manipulator can be designed for a picture generating unit for creating a multicolored image representation. In this case, the picture generating unit can be designed to emit light with the wavelengths or frequencies of at least one defined color space. The color space can be, for example, an RGB color space (RGB—Red Green Blue) or a CMY color space (CMY—Cyan Magenta Yellow).

The at least two holographic elements are configured to be reflective for example for at least two differing defined wavelengths and a defined angle of incidence range. Preferably, the at least two holographic elements are configured to be reflective for at least two differing, non-overlapping defined wavelength ranges and a defined angle of incidence range. Advantageously, the at least two holographic elements are configured to be transmissive for defined wavelength ranges and/or at least one defined angle of incidence range for which they are configured not to be reflective. Filter effects are reduced or avoided as a result.

In one preferred example variant, the wavefront manipulator comprises at least one optical element which has a freeform surface, i.e. an optically effective freeform surface, and is designed for arrangement in the beam path between the picture generating unit and the holographic arrangement. The optical element comprising the freeform surface contributes to an improvement in the resolution by way of a corresponding configuration of the freeform surface and allows a targeted correction of imaging aberrations. Furthermore, the optical element takes up only very little installation space on account of the freeform surface. In other words, it also makes a considerable contribution to an improvement in the imaging quality of a head-up display having a compact configuration.

The optical element having the freeform surface can be configured to be reflective and/or transmissive. A reflective configuration is particularly advantageous in association with an application for head-up displays having a compact configuration since, in this way, the optical element can simultaneously contribute to a beam deflection that is necessary anyway, even at high angles of incidence, without in the process inducing additional image aberrations such as chromatic aberrations, in particular. Preferably, the freeform surface is formed to at least partly correct at least one aberration or one imaging aberration. That can be at least one of the imaging aberrations mentioned at the outset. The imaging aberration(s) can be caused by the tilt of the image plane and/or by the projection surface, in particular in the case of a curved projection surface, and/or can be caused by the picture generating unit and/or by the geometry of the beam path, for example in the context of a head-up display. Furthermore, the resolution and thus the imaging quality can be optimized by means of the freeform surface.

Preferably, the freeform surface has a surface geometry which is derived from an imaging function dependent on at least one defined parameter. The at least one defined parameter can arise from an envisaged application of the wavefront manipulator. The optical element can have a plurality of freeform surfaces, in particular in order to be able to perform corrections of aberrations adapted to the respective application geometry.

Preferably, each of the at least two holographic elements comprises a number of holograms. In this case, each hologram is recorded or generated with at least one defined wavelength. A holographic element can comprise a plurality of holograms, for example, which can be arranged one on top of another as a stack. For example, a holographic element can have a number, preferably a plurality, of monochromatic holograms. As an alternative thereto, a holographic element can comprise at least one hologram which is recorded or generated with at least two defined wavelengths. Preferably, such a hologram is recorded with three different wavelengths of a defined color space, for example is configured as an RGB hologram or a CMY hologram or as a hologram formed from a number of individual wavelengths of a different color space. In the examples mentioned, R stands for Red, G stands for Green, B stands for Blue, C stands for Cyan, M stands for Magenta, and Y stands for Yellow.

Therefore, at least one, preferably two, of the at least two holographic elements can comprise at least two, preferably three, holograms which are configured to be reflective for mutually different wavelengths. In addition to that or in an alternative, at least one, preferably two, of the at least two holographic elements can comprise at least one hologram which is configured to be reflective for at least two, preferably three, mutually different wavelengths. In other words, the holograms mentioned have been recorded with correspondingly mutually deviating wavelengths.

For example, of the at least two holographic elements, a first holographic element can comprise at least one hologram which is designed or efficient for a first color, preferably three holograms, each of which is designed for one of the three colors of a color space, and a second holographic element can comprise at least one hologram which is designed or efficient for the first color, preferably three holograms, each of which is designed for one of the three colors of the color space. The two holographic elements can be arranged against one another such that a stack composed of the holograms of the first holographic element is arranged against a stack composed of the holograms of the second holographic element. However, holograms assigned to one another can also be arranged directly adjacent to one another. In this case, only individual portions of the holographic elements are arranged one directly behind another. That is to say that, for example, that hologram of the first holographic element which is designed for a first color can be arranged directly adjacent to that hologram of the second holographic element which is designed for the first color, that hologram of the first holographic element which is designed for a second color can be arranged directly adjacent to that hologram of the second holographic element which is designed for the second color, etc.

The arrangement of the individual holograms of a holographic element or of the totality of the holograms of the holographic arrangement can be used as a degree of freedom in order to avoid filter effects between the holograms. The individual, mutually differing holograms of a holographic element can be arranged next to one another and/or one behind another in relation to a center line or center axis, which can coincide with the optical axis, or in relation to some other defined geometric parameter of the holographic element.

By way of example, the first holographic element can be arranged mirror-symmetrically with respect to the second holographic element in relation to the arrangement of the individual holograms. For example, the first holographic element can comprise a hologram recorded with red light, a hologram recorded with green light and a hologram recorded with blue light, which are arranged one on top of another in the order mentioned. The second holographic element can likewise have a hologram recorded with red light, a hologram recorded with green light and a hologram recorded with blue light, which are likewise arranged one on top of another in this order. In the case of a mirror-symmetrical arrangement, the first holographic element and the second holographic element are arranged one on top of another or adjacent to one another in such a way that for example the hologram of the first holographic element recorded with red light is arranged directly adjacent to the hologram of the second holographic element recorded with red light. As an alternative thereto, the arrangement of the holograms of the first holographic element can be identical to the arrangement of the holograms of the second holographic element in relation to a defined direction. For example, both holographic elements can have holograms arranged in the order RGB (R—hologram recorded with red light, G—hologram recorded with green light, B—hologram recorded with blue light) in relation to a defined direction, which are arranged against one another in such a way that the hologram R of one holographic element adjoins the hologram B of the other holographic element. Any other mutually deviating arrangements are likewise possible, for example RGB adjoining or adjacent to GBR, or R adjoining or adjacent to R, G adjoining or adjacent to G, and B adjoining or adjacent to B, etc.

In the simplest case, the holographic arrangement can comprise a first holographic element and a second holographic element, a plurality of the holograms or all of the holograms of the respective holographic element being configured identically or the same, with the exception of the wavelength for which they are designed. In other words, a plurality or all of the holograms of the first holographic element can be configured identically and can differ from one another only in regard to the wavelength for which they are designed. Analogously, a plurality or all of the holograms of the second holographic element can be configured identically and can differ from one another only in regard to the wavelength for which they are designed.

In a further example variant, a plurality of the holograms of at least one of the holographic elements are recorded with two design wavefronts. Of the latter, at least one design wavefront of at least one hologram of the holographic elements is identical to at least one design wavefront of another hologram of one of the holographic elements, in particular of the first and/or of the second holographic element, with regard to the wavelength and the angle of incidence. The use of identical design wavefronts for different wavelengths has the advantage that the required holograms can be produced with little outlay and high precision. However, it is also possible for the design wavefronts to slightly differ from one another with regard to the wavelength and/or the angle of incidence. For example, the angles of incidence can differ from one another by 1 to 2 degrees. The difference can be used to compensate for material shrinkage and to optimize the homogeneity of the efficiency.

The jointly used design wavefront is preferably defined as a plane wave which leads to a minimal filter effect between different wavelengths. The direction of incidence of the design wavefront for the at least two holographic elements of the holographic arrangement can be used as a degree of freedom in order to avoid filter effects between different wavelengths. The direction of incidence can also be chosen differently for each wavelength. In a simple case, the design wavefronts for the at least two wavelengths, preferably for this the three wavelengths, are the same design wavefronts for each holographic element and differ only in the wavelength used.

In principle, the at least two holographic elements can comprise reflection holograms recorded with two design wavefronts, of which at least one design wavefront is a plane wavefront or a spherical wavefront or a freeform wavefront.

In connection with correcting a plurality of aberrations in the case of a tilted image plane, it is advantageous if the at least two holographic elements comprise reflection holograms, at least one reflection hologram being recorded or written with two design wavefronts, at least one of the design wavefronts being formed such that it is/they are created in accordance with a function or formation specification comprising polynomials, for example, which has a plurality of degrees of freedom, i.e. a plurality of parameters that are settable independently of one another. The highest possible number of degrees of freedom is required for effectively correcting as many imaging aberrations as possible. This can be realized by way of corresponding design wavefronts by means of a single compact component.

The at least two holographic elements are preferably configured such that a first holographic element comprises at least one hologram assigned to a hologram of a second holographic element, holograms assigned to one another being configured with pointwise diffraction efficiency in relation to one another. In order to determine the diffraction efficiency, either the intensity of the 1st order of diffraction is expressed as a ratio with respect to the sum of the intensity of the 1st order of diffraction and the intensity of the 0th order of diffraction, or the intensity of the 1st order of diffraction is expressed as a ratio with respect to the total incident intensity. Pointwise diffraction efficiency thus means, in other words, that at least one point of the first holographic element is designed to diffract light having at least one defined wavelength and in a defined angle of incidence range to a point of the second holographic element which in turn diffracts the light diffracted by the first holographic element. Preferably, the efficiency is more than 90 percent.

The distance between the holograms and the thickness thereof are negligible compared with the dimension or the extent of the wavefront manipulator or of an optical arrangement comprising the wavefront manipulator. The holographic arrangement is therefore free of aberrations potentially caused by an extent in the direction of an optical axis. The design wavefronts of the holographic elements can furthermore be used as a degree of freedom for the compensation of material tolerances, for example for the compensation of material shrinkages. In this case, the general design wavefronts differ slightly from one another.

Preferably, the at least two holographic elements are arranged at a distance from one another of less than one millimeter, in particular of less than 0.5 millimeter and preferably of less than 0.1 millimeter. The distance is preferably zero or negligible. As a result, firstly, a high imaging quality is achieved; additionally, the individual holographic elements do not have to be subsequently adjusted in regard to their position with respect to one another.

The holographic arrangement can be configured in the form of a layer or a film or a substrate, for example in the form of a volume hologram, or a plate. In addition to that or in an alternative, the holographic arrangement can have a planar surface or a curved surface. The holographic arrangement can be arranged or have been arranged for example at or on a surface of a cover glass or of some other optical component that is present anyway. In this way, no additional installation space is taken up. For example, the wavefront manipulator can comprise an optical component configured to be transmissive and designed to be arranged in the beam path between the holographic arrangement and the projection surface. In this case, the holographic arrangement can preferably be arranged at a surface—which faces away from the projection surfaces—of the optical component configured to be transmissive. Both the optical component fashioned to be transmissive and the holographic arrangement can be configured to be curved, preferably with the same curvature. The aforementioned optical component fashioned to be transmissive can be a so-called glare trap, for example, which is usually arranged at a position between a windshield and a head-up display and which is designed to reflect sunlight in a defined direction so that it is not reflected in the direction of the eyebox via the head-up display. In this configuration variant, the holographic arrangement and the glare trap are preferably configured with the same curvature and arranged directly adjacent to one another.

Overall, the wavefront manipulator, by way of the holographic elements, enables a significantly greater or more extreme deflection of the used light than is possible with traditional refractive optical components. Moreover, high-quality multicolored image representations are projectable into a tilted image plane.

The optical arrangement for a head-up display on a projection surface, for example a curved projection surface, comprises a picture generating unit and a wavefront manipulators as described above. The picture generating unit advantageously comprises an object plane, i.e. is spatially extended, the object plane being designed to emit light in a defined emission angle range and with a defined maximum bandwidth with regard to the wavelengths of the emitted light. The object plane can be determined or defined by the exit pupil of the picture generating unit. Preferably, the picture generating unit is designed for creating a multicolored image representation.

For example, each light-emitting point of the object plane emits light in the form of a scattering lobe or in a defined angular range. This can be achieved for example by the use of a diffuser. Preferably, the picture generating unit is designed to emit laser light, in particular laser beams. Advantageously, the picture generating unit is designed to emit laser light in at least two, preferably at least three, different waves. That preferably involves three different wavelengths of a defined color space, for example red, green and blue or cyan, magenta and yellow. Since the holographic elements are more sensitive with regard to the bandwidth of each wavelength compared with other optical components, such as mirrors and lens elements, for example, it is advantageous if the picture generating unit is configured as a laser scanner having a sharp bandwidth for each color.

The optical arrangement according to certain example embodiments preferably has a volume of less than 15 liters, e.g. less than 10 liters, i.e. in other words occupies an installation space of less than 10 liters. The optical arrangement has the features and advantages already mentioned above in connection with the wavefront manipulator. It offers in particular a head-up display which is fashioned very compactly, i.e. occupies just a small installation space, and at the same time ensures a very high imaging quality.

Both the wavefront manipulator and the optical arrangement are suitable for retrofitting in for example motor vehicles, aircraft or VR arrangements, for example VR glasses.

The head-up display in certain example embodiments comprises a curved projection surface and an above-described optical arrangement. The curved projection surface is, for example, a windshield of a vehicle, for example of a motor vehicle, of an aircraft or of a ship. However, the curved projection surface can also be some other observation window, for example an observation window of VR glasses. The curved projection surface can be regarded as a freeform surface, for example. Imaging aberrations, or aberrations, that are caused thereby are compensated for by means of the wavefront manipulator, and a tilted image plane of a virtual image representation is moreover created.

The head-up display makes it possible to create a virtual image in a tilted image plane with a large field of view. For example, it is possible to create a rectangular virtual image which has a field of view of, for example, at least 10 degrees, preferably at least 15 degrees times 5 degrees (FOV: 15°×5°), and is observable at a specific distance away from the eyebox, for example at a distance of between 6 meters and 12 meters. The eyebox can have dimensions of up to 150 mm×150 mm.

The brightness and the uniformity of the virtual image can be optimized by way of corresponding design waves of the holographic elements. Furthermore, the uniformity of the degree of whiteness can be set by setting of the factor of the color mixture, for example of the RGB color space, in the picture generating unit.

The invention is explained in greater detail below on the basis of exemplary embodiments with reference to the accompanying figures. Although the invention is more specifically illustrated and described in detail by means of the preferred exemplary embodiments, the invention is not restricted by the examples disclosed and other variations can be derived therefrom by a person skilled in the art, without departing from the scope of protection of the invention.

The figures are not necessarily accurate in every detail and to scale, and may be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

FIG. 1 schematically shows the beam path of a head-up display for a windshield of a motor vehicle in a side view.

FIG. 2 schematically shows the beam path of a head-up display according to certain example embodiments of the invention for a windshield of a motor vehicle in a side view.

FIG. 3 schematically shows the Scheimpflug principle for creating a tilted image plane.

FIGS. 4-8 schematically show examples of in each case two reflection holograms assigned to one another with their design wavefronts.

FIG. 9 schematically shows the beam path within a hologram stack.

FIG. 10 schematically shows the beam path of the head-up display shown in FIG. 2 including a created image representation in a plan view.

FIG. 11 schematically shows an optical arrangement according to certain example embodiments of the invention with a wavefront manipulator in the form of a block diagram.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

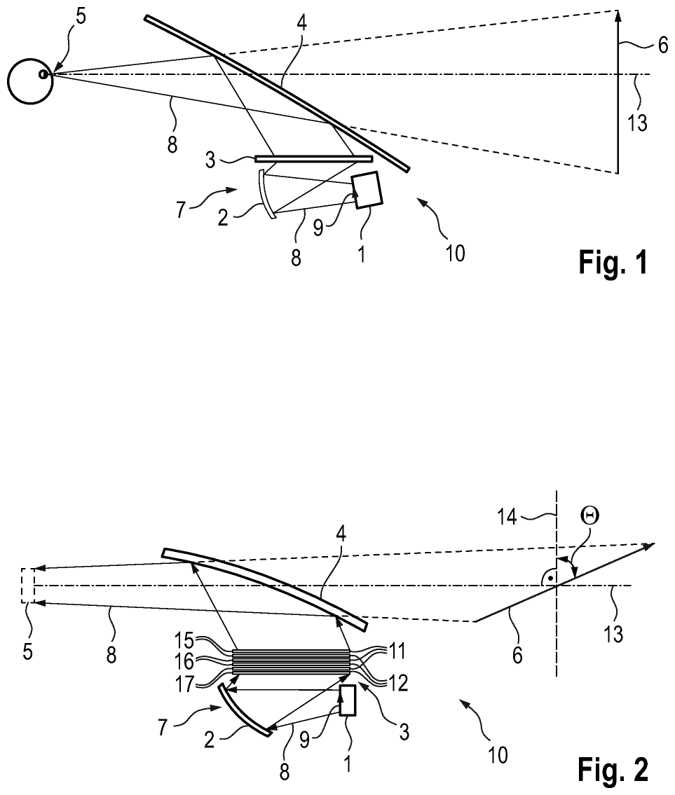

FIG. 1 schematically shows the beam path of a head-up display 10. The head-up display 10 comprises a picture generating unit 1, a projection surface 4, for example in the form of a windshield of a motor vehicle, and a wavefront manipulator 7. The projection surface 4, for example the windshield, can be configured in curved fashion. In the case of an application for a vehicle, the picture generating unit 1 and the wavefront manipulator 7 are preferably arranged in a manner integrated in a fitting (not shown). The head-up display 10 is configured such that it creates a virtual image 6 on or behind the projection surface 4, in particular on or behind the surface of the windshield, i.e. in the external region of the vehicle, for example in the direction of travel behind the surface of the windshield. The imaged object output by the imaging unit 1 or the exit pupil of the imaging unit 1 is identified by an arrow with the reference numeral 9.

In the configuration variant shown, the wavefront manipulator 7 comprises a holographic arrangement 3 and an optical element 2 which is configured to be reflective and which has a freeform surface and is arranged in the beam path 8 proceeding from the picture generating unit 1 between the picture generating unit 1 and the holographic arrangement 3. The optical element 2 is preferably configured as a freeform mirror.

The picture generating unit 1 emits light waves in the direction of the wavefront manipulator 7. The wavefront manipulator 7 is used to correct imaging aberrations and optionally to expand the beam path. The wavefront manipulator 7 guides light waves in the direction of the projection surface 4, in particular the curved projection surface. At the projection surface 4, the light waves are reflected in the direction of an eyebox 5. In this case, the eyebox 5 forms the region in which a user must or can be situated in order to be able to perceive the virtual image 6 generated by the head-up display 10. The conventional head-up display 10 shown comprises a virtual image plane 6 which runs perpendicular to an optical axis 13 in the region of the image plane and which has a fixed image distance that is identical for all image points.

FIG. 2 schematically shows the beam path of a head-up display 10. The head-up display 10 is designed such that it is tilted through an angle θ in relation to a plane 14 extending perpendicular to the optical axis 13 in the region of the image plane 6. The angle θ is between 10 degrees and 170 degrees and preferably between 30 degrees and 150 degrees, in particular between 40 degrees and 50 degrees or between 130 degrees and 140 degrees. In this way, different image distances are created by one image plane 6. This is advantageous in that information items can be projected at different image distances. This is especially relevant in the context of head-up displays for vehicles. In the case of a tilt as depicted in FIG. 2, in which the upper region of the image plane 6 has a greater image distance from the eyebox 5 than the lower region of the image plane 6, information items in the lower region of the image plane 6 can be imaged at a shorter distance from the eyebox 5. For example, information regarding the vehicle speed can be placed here. Information items which can be imaged further away from an observer or an eye box 5 can be imaged in the upper region of the image plane 6. For example, these could be navigation information items or alerts.

In the variant shown in FIG. 2, the holographic arrangement comprises a first holographic element 11 and a second holographic element 12 which are arranged one directly behind another in portions. Each of the holographic elements 11, 12 comprises three holograms 15, 16, 17, which are configured as reflection holograms and are each diffraction-efficient in reflection for at least one defined wavelength or frequency and a defined angle of incidence range. For a defined angle of incidence range, the holograms 15 are efficient for at least one wavelength of a first color in a defined color space, for example for blue light, the holograms 16 are efficient for at least one wavelength of a second color in a defined color space, for example for green light, and the holograms 17 are efficient for at least one wavelength of a third color in a defined color space, for example for red light, in the example shown.

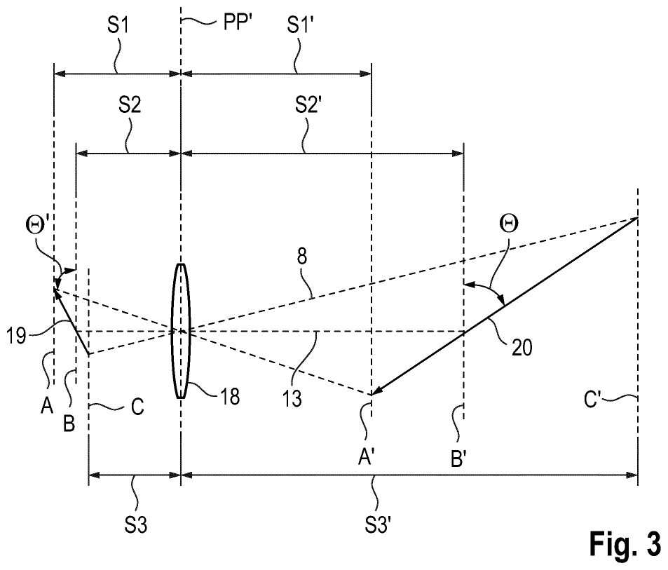

A tilted image plane 6 can be created by means of the so-called Scheimpflug principle. The Scheimpflug principle is explained below on the basis of FIG. 3. In FIG. 3, a single lens 18 is used to create an image representation 20 of an object 19 in a tilted image plane. If the lens 18 is very thin, the arrangement behaves almost like a paraxial or ideal imaging system. The two principal planes (PP′ plane) are located together in the lens plane. If the object plane is arranged parallel to the lens plane then all field points in the object plane have the same distance from the principal planes. Thus the magnification is the same for all field points in the object plane. The imaged points are all located in a plane with the same distance from the principal planes. Thus the object plane, the lens plane and the image plane are arranged parallel to one another.

If the object plane 19 is tilted through an angle θ′, then the points on the object plane have different distances (for example S₁, S₂, S₃) from the principal planes. Accordingly, the image points are located in a tilted image plane 20 at an angle θ. Such an imaging principle with a tilted object plane 19 and tilted image plane 20 is called the Scheimpflug principle. The angles θ and θ′ are related to the magnification of the system. The challenge of a Scheimpflug system consists in the aberrations being very different for different image distances S′. It is therefore necessary to correct, where possible, all aberrations well for different image distances (A to C in FIG. 3) in order to obtain good imaging performance. In FIG. 3, an object distance S₁ is given for an object plane A, an object distance S₂ is given for an object plane B, and an object distance S₃ is given for an object plane C. The object plane A is imaged into an image plane A′ with an object distance S₁′, the object plane B is imaged into an image plane B′ with an image distance S₂′, and the object plane C is imaged into an image plane C′ with an image distance S₃′.

For an augmented reality RGB head-up display (AR-RGB-HUD), the eyebox and the field of view already have comparatively large extents. The optical components have limited correction capability within a certain installation space with a defined number of components. An additional challenge for the optical correction lies in the realization of a good performance for all points in the image plane in the case of a plurality of image distances. Thus, the correction requires either more components or more degrees of freedom of the components.

A holographic arrangement 3 is used in conjunction with a tilted imaging plane in order to reduce the installation space and offer more degrees of freedom for the correction. The holographic arrangement 3 can offer many degrees of freedom for wavefront manipulation. Aberrations of different image distances can be corrected in conjunction with the at least one element 2 configured as a freeform component, for example as a freeform mirror. The holographic arrangement 3 between the projection surface 4, for example the windshield, and the freeform component 2 has the additional function of enabling significant refractive power without chromatic aberrations and having a very small volume. This makes it possible to create an AR-RGB-HUD with a much smaller volume in comparison with a conventional HUD that only uses freeform components for correcting aberrations.

The challenge with regard to an HUD system lies in the specifications, for example the size of the eye box, of the FOV, of the displacement of the image distance or of the installation space. Should the installation space and the number of components be fixedly predetermined, the holographic arrangement 3 can provide additional potential for realizing an efficient aberration correction. The degrees of freedom required to this end can be realized by a generation of the utilized holograms by means of design wavefronts which contain or implement the required degrees of freedom.

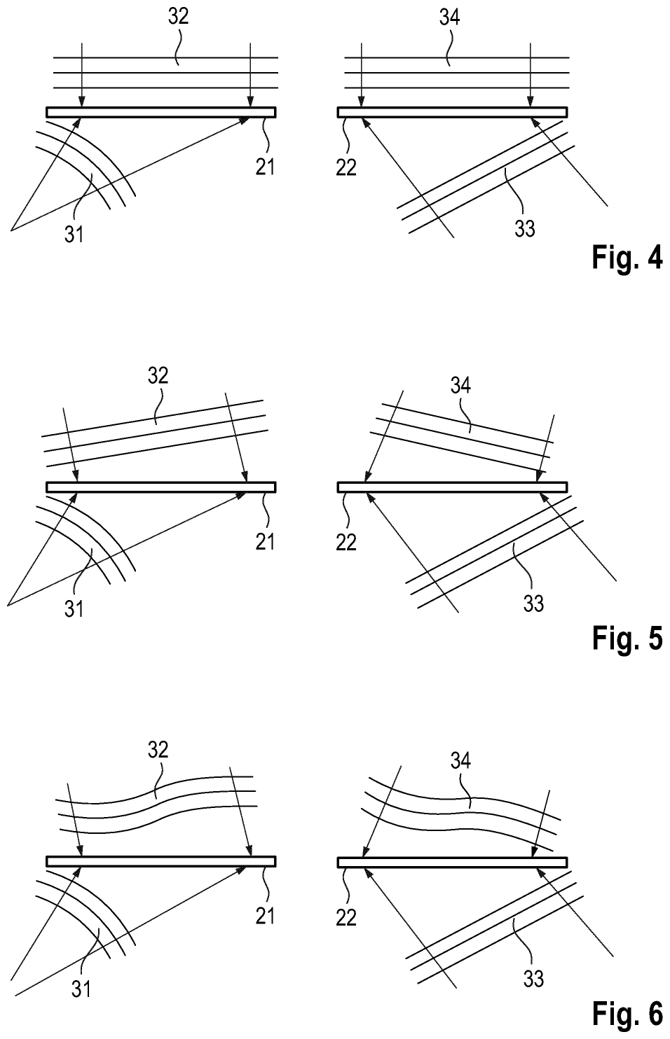

FIGS. 4 to 8 each show holograms designed for a specific wavelength or frequency or for a specific wavelength range or frequency range. With reference to FIGS. 4 to 8, an explanation is given hereinafter of examples of in each case two holograms 21 and 22 which are used as reflection holograms assigned to one another, with the design wavefronts thereof. The holograms 21 and 22 can be for example the holograms 14, 15 or 16 from FIG. 2. For example, the first holographic element 11 can comprise the hologram 21, and the second holographic element 11 can comprise the hologram 22. FIG. 9 shows the relative arrangement of the holograms 21 and 22, which are assigned to one another, and shows the beam path within a correspondingly constructed hologram stack.

In FIG. 4, a first hologram 21 for reflecting light having a defined wavelength, for example for green light, is shown on the left. A second hologram 22 is shown on the right, which is designed as a reflection hologram for light having the same color as the first hologram 21 and which interacts with the first hologram 21, as shown in FIG. 9, in the context of the holographic arrangement 3. The design wavefronts for the first hologram 21 are identified by the reference numerals 31 and 32. The design wavefronts for the design of the second hologram 22 are identified by the reference numerals 33 and 34. In the example shown, the first hologram 21 is exposed, i.e. written, with a spherical wavefront 31 and a plane wavefront or planar wavefront 32, and the second hologram 22 is written with two planar wavefronts or plane wavefronts 33 and 34. The wavefronts 31 and 33 define the directions of the light toward the components, i.e. upon entering the holographic arrangement and upon exiting the holographic arrangement, and also the refractive power of the entire holographic arrangement constructed from these holograms 21 and 22. The design wavefronts 32 and 34 define the reproduction wavefronts between the two holograms 21 and 22 (see wavefront 36 in FIG. 9). In this case, it is necessary to ensure that a filtering effect between different colors or wavelengths is avoided. Filtering effects are avoided by way of corresponding differences in the exposure wavelengths and/or a suitable definition of the exposure angles of the wavefronts 32 and 34. In the variant shown in FIG. 4, the directions of the wavefronts 32 and 34 are identical.

The wavefront 31 can be formed from a sum of a spherical wavefront and a freeform wavefront. In this case, the wavefront can be represented by a polynomial expansion of a sum of Zernike polynomials, the individual Zernike polynomials Z being multiplied by coefficients c(Z). For tilt angles θ between 0 and 80 degrees, the following table gives examples of suitable values for coefficients c(Z) of the Zernike polynomials Z5 to Z9, in particular for an arrangement with a non-curved windshield as shown schematically in FIG. 2. The Zernike polynomial Z5 corrects astigmatism at 45°, Z6 corrects astigmatism at 0°, Z7 corrects coma in the x-direction, Z8 corrects coma in the y-direction, and Z9 corrects spherical aberration.

| ⊖ [°] | c(Z5) | c(Z6) | c(Z7) | c(Z8) | c(Z9) |
|---|---|---|---|---|---|
| 0 | 1.23 E−06 | 1.36 E−06 | −1.02 E−09 | −7.31 E−15 | 3.02 E−13 |
| 10 | 1.79 E−06 | 1.46 E−06 | −3.39 E−09 | −2.37 E−10 | 2.56 E−13 |
| 20 | 1.83 E−06 | 1.50 E−06 | −2.95 E−09 | −6.75 E−10 | 7.30 E−13 |
| 30 | 1.88 E−06 | 1.55 E−06 | −2.45 E−09 | −1.18 E−09 | 1.27 E−12 |
| 40 | 1.93 E−06 | 1.61 E−06 | −1.82 E−09 | −1.80 E−09 | 1.93 E−12 |
| 50 | 1.99 E−06 | 1.70 E−06 | −9.64 E−10 | −2.65 E−09 | 2.83 E−12 |
| 60 | 2.08 E−06 | 1.82 E−06 | 3.87 E−10 | −3.96 E−09 | 4.20 E−12 |
| 70 | 2.28 E−06 | 1.88 E−06 | 2.91 E−09 | −6.07 E−09 | 6.47 E−12 |
| 80 | 2.90 E−06 | 1.69 E−06 | 1.06 E−08 | −1.17 E−08 | 1.23 E−11 |

In the variant shown in FIG. 5, in order to improve the homogeneity of the brightness and the color homogeneity, two design wavefronts 32 and 34 differing from one another in terms of their direction of incidence are used.

In the variant shown in FIG. 6, the design wavefronts 32 and 34 are formed as freeform wavefronts. The homogeneity can thereby be improved to an even higher level. The wavefronts 32 and 34 can be adjusted in particular locally by means of complicated exposure systems. The shape of the wavefronts and the angle of incidence can be specified in this way.

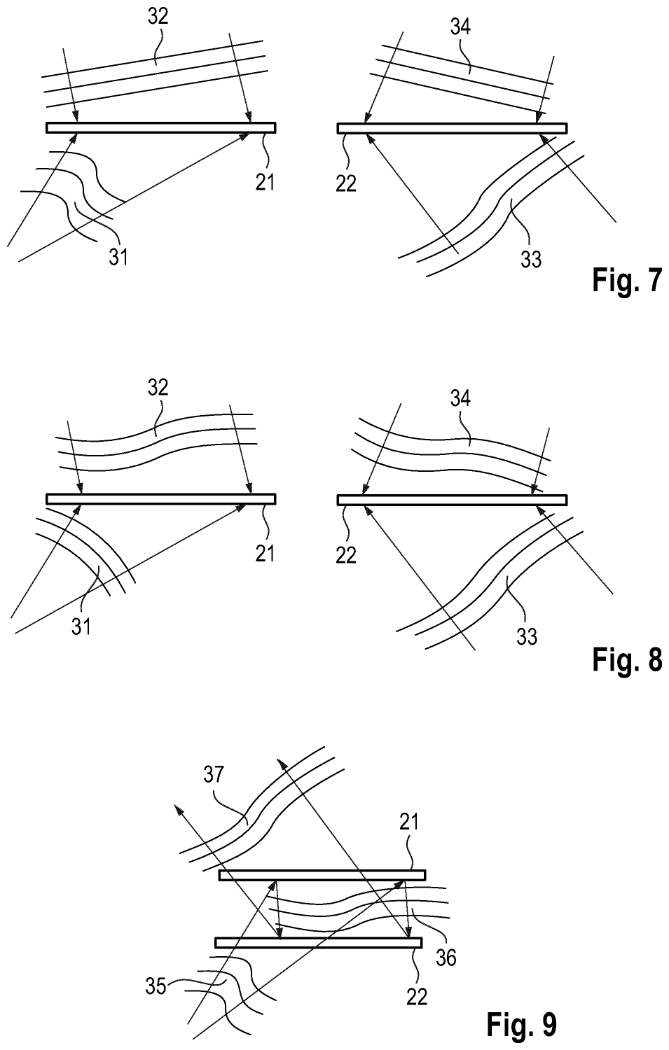

In the variant shown in FIG. 7, the design wavefronts 31 and 33 are configured as freeform wavefronts, which moreover differ from one another with regard to their shape and their angle of incidence. The design wavefronts 32 and 34, as in FIG. 5, are formed as plane waves with mutually different angles of incidence.

The configurations shown offer a high number of degrees of freedom. Required degrees of freedom are usually implemented by freeform components. In the variant shown here, corresponding requirements can be realized by means of the holograms used, the required degrees of freedom being realized by a corresponding freeform exposure by means of the design wavefronts 31, 32, 33 and 34. For the imaging quality and in particular the aberration correction, the wavefronts 31 and 33 in the variant shown in FIG. 7 are used. As a result, the holograms 21 and 22 designed or written in this way bear complicated microstructures that are designed to correct numerous aberrations.

The variant shown in FIG. 8 is suitable for applications with very demanding requirements. In this case, all four wavefronts 31-34 can be designed as freeform wavefronts in order to realize a maximum number of degrees of freedom of the hologram stack.

FIG. 9 shows the beam path through a hologram stack constructed from the holograms 21 and 22, for example in the context of an optical arrangement or an HUD 10. Light with a corresponding wavefront coming from the picture generating unit 1 is guided in the direction of the holographic arrangement 3, for example by way of further freeform components 2. The light or the wavefront 35 is firstly transmitted through the second hologram 22 and is subsequently reflected at the first hologram 21. The wavefront reflected by the first hologram 21 is identified by the reference numeral 36. This wavefront 36 is reflected at the second hologram 22 and subsequently transmitted by the first hologram 21. The corresponding wavefront 37 subsequently leaves the holographic arrangement 3 and is guided in the direction of the projection surface 4.

Reflection holograms 21 and 22 assigned to one another, i.e. holograms which are designed for reflecting wavelengths or frequencies coordinated with one another, i.e. identical wavelengths or frequencies or wavelength ranges or frequency ranges which at least partly overlap one another, and/or for angle of incidence ranges coordinated with one another or have at least a pointwise mutual efficiency, can be arranged directly adjacent to one another within the holographic arrangement 3, as shown in FIG. 2. However, it can also comprise a first holographic element 11 comprising a plurality of first holograms which are designed and are efficient in each case for different wavelengths or wavelength ranges, and a second holographic element 12 comprising a plurality of second holograms which are respectively assigned to the first holograms, i.e. are designed or efficient for the same wavelengths or wavelength ranges as the first holograms. In this case, the first holographic element 11 and the second holographic element 12 can preferably be arranged directly adjacent to one another. In order to avoid filtering effects, the holograms are preferably designed to be transmissive for those wavelengths or frequencies of the color space used for which they are not efficient or designed as reflection holograms.

Freeform wavefronts for the hologram design are not only useful for a Scheimpflug HUD but are also suitable for realizing other HUD systems with high specifications, for example in order to realize a large eyebox and a large FOV. Application options correspondingly arise for the wavefront manipulator and the optical arrangement.

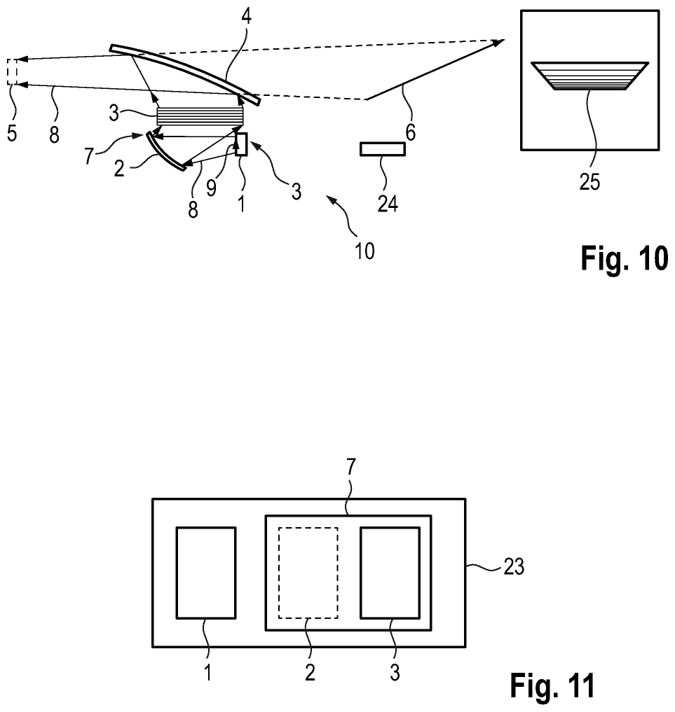

Imaging an image created by a picture generator 1 into an inclined or tilted virtual image representation 6, as shown in FIG. 2, leads to the virtual image 25 suffering from a keystone distortion if the image 24 is displayed rectangularly on the picture generator or the picture generating unit 1. An appropriate image to be imaged is shown next to the picture generating unit 1 in FIG. 10, which otherwise corresponds to FIG. 2, and is identified by reference numeral 24. A corresponding virtual image imaged on the virtual image plane 6 is shown next to the virtual image plane 6 and identified by the reference numeral 25. The distortion results from different magnifications for different image distances. This keystone distortion can be corrected digitally. Should the brightness be the same everywhere on the picture generating unit 1, the brightness of the virtual image differs as a result of the different magnifications, in a manner depending on the image distance of the individual image point. In the example shown, the brightness of the virtual image 25 is greater in the lower region than in the upper region. The brightness can also be adjusted digitally. For example, the image of the picture generating unit 1 can have a greater brightness in the upper region than in the lower region.

FIG. 7 schematically shows an optical arrangement 23 with a wavefront manipulator 7 in the form of a block diagram. The optical arrangement 23 comprises a picture generating unit 1 and a wavefront manipulator 7, which are arranged one behind another in a beam path 8. The wavefront manipulator 7 comprises a holographic arrangement 3 already described, and optionally an optical element 2 already described in association with FIG. 2, said optical element having a freeform surface and preferably being configured as a freeform mirror. In this case, the optical element 2 is arranged in a beam path between the picture generating unit 1 and the holographic arrangement 3.

### LIST OF REFERENCE SIGNS

1 Picture generating unit
2 Optical element
3 Holographic arrangement
4 Projection surface
5 Eyebox
6 Virtual image
7 Wavefront manipulator
8 Beam path
9 Object/object plane/exit pupil
10 Head-up display
11 First holographic element
12 Second holographic element
13 Optical axis
14 Plane perpendicular to the optical axis
15 Hologram, diffraction-efficient in reflection for a first wavelength
16 Hologram, diffraction-efficient in reflection for a second wavelength
17 Hologram, diffraction-efficient in reflection for a third wavelength
18 Lens
19 Object
20 Image representation
21 Hologram
22 Hologram
23 Optical arrangement
24 Image to be projected
25 Image representation
31 Design wavefront
32 Design wavefront
33 Design wavefront
34 Design wavefront
35 Wavefront
36 Wavefront
37 Wavefront
A Plane
B Plane
C Plane
A′ Plane
B′ Plane
C′ Plane
P Principal plane
P′ Principal plane
S Distance from the principal plane
S′ Distance from the principal plane
θ Tilt angle of the image plane
θ′ Tilt angle of the object plane

1-15. (canceled)

16. A wavefront manipulator for arrangement in the beam path of a head-up display between a picture generating unit and a projection surface, the wavefront manipulator comprising:
a holographic arrangement comprising a first holographic element and a second holographic element, the first and second holographic elements being arranged one directly behind another at least in portions in the beam path, and being configured to be reflective for at least one defined wavelength and a defined angle of incidence range,
wherein the first holographic element comprises at least one hologram which is assigned to a hologram of the second holographic element for reflection purposes,
wherein for at least one defined object plane, the wavefront manipulator is configured to create an image plane of a virtual image representation, the image plane being tilted through a defined tilt angle θ with respect to a plane arranged perpendicular to the optical axis in the region of the image plane of a virtual image representation, and
wherein the holographic arrangement is configured for at least partial correction of at least one imaging aberration of a virtual image representation created in the tilted image plane.

17. The wavefront manipulator of claim 16, wherein the holographic arrangement is configured for at least partial correction of at least one imaging aberration which is caused by the tilt of the image plane.

18. The wavefront manipulator of claim 16, wherein the tilt angle θ is in the range of 10 degrees to 170 degrees.

19. The wavefront manipulator of claim 16, wherein the at least one defined object plane is arranged tilted through a defined tilt angle with respect to a plane arranged perpendicular to the optical axis in the region of the object plane.

20. The wavefront manipulator of claim 16, wherein the wavefront manipulator is configured for manipulating a wavefront for creating a multicolored virtual image representation.

21. The wavefront manipulator of claim 16, wherein the first and second holographic elements are configured to be reflective for at least two differing defined wavelengths and a defined angle of incidence range.

22. The wavefront manipulator of claim 16, wherein the first and second holographic elements are configured to be reflective for at least two differing, non-overlapping defined wavelength ranges and a defined angle of incidence range.

23. The wavefront manipulator of claim 16, wherein the first and second holographic elements are configured to be transmissive for defined wavelength ranges and/or at least one defined angle of incidence range for which they are configured not to be reflective.

24. The wavefront manipulator of claim 16, wherein the first and second holographic elements comprise reflection holograms recorded with two design wavefronts, of which at least one design wavefront is a plane wavefront or a spherical wavefront or a freeform wavefront.

25. The wavefront manipulator of claim 16, wherein the first and second holographic elements each comprise reflection holograms, at least one reflection hologram being recorded with two design wavefronts, at least one of the design wavefronts being formed such that it is/they are created in accordance with a function having a plurality of degrees of freedom.

26. The wavefront manipulator of claim 16, wherein the first and second holographic elements are configured such that the first holographic element comprises at least one hologram assigned to a hologram of the second holographic element, holograms assigned to one another being configured with pointwise diffraction efficiency in relation to one another.

27. An optical arrangement for a head-up display for a projection surface, comprising:
a picture generating unit; and
the wavefront manipulator of claim 16.

28. The optical arrangement of claim 27, wherein the picture generating unit comprises an object plane which is designed to emit light in a defined emission angle range and with a defined maximum bandwidth with regard to the wavelengths of the emitted light.

29. The optical arrangement of claim 27, wherein the picture generating unit is configured to create a multicolored image representation.

30. A head-up display, comprising:
a projection surface; and
the optical arrangement of claim 27.
